(19) United States
(12) Patent Application Publication
(10) Pub. No.: US 2018/0135590 A1
(43) Pub. Date: May 17, 2018

(54) Controlling Engine Ignition

(71) Applicant: Woodward, Inc., Fort Collins, CO (US)

(72) Inventors: Stephan M. Brandl, JR., Fort Collins, CO (US); Kennabec J. Walp, Saline, MI (US); Christopher D. Rutt, Loveland, CO (US); Muftah Omar Shawesh, Fort Collins, CO (US); John A. Underwood, Loveland, CO (US)

(21) Appl. No.: 15/352,374

(22) Filed: Nov. 15, 2016

(51) Int. Cl. F02P 17/02; F02P 17/10; F02P 9/00

(52) U.S. Cl. CPC F02P 17/02; F02P 9/002; F02P 17/10

(57) ABSTRACT

An ignition control system for an internal combustion engine has a coil connector for connecting to an ignition coil, a processor coupled to the coil connector, and a memory coupled to the processor. The memory contains instructions for the processor to, in communication with the ignition coil, achieve and maintain a target spark duration by dynamically controlling a coil dwell set-point of the ignition coil. The processor energizes the ignition coil during a first ignition sequence based on the coil dwell set-point, directly measure spark duration of the first ignition sequence by monitoring a voltage reflection on a primary side of the ignition coil, adjust the coil dwell set-point for a second ignition sequence based on the target spark duration and the measured spark duration, and energizes the ignition coil during the second ignition sequence based on the adjusted coil dwell set-point.

### BACKGROUND

Internal combustion engines, including gasoline engines and natural gas engines, ignite an air-fuel mixture to produce combustion in one or more engine cylinders. Typical internal combustion engine systems inject fuel and air into a combustion chamber (i.e., the cylinder) of the engine and ignite the fuel-air mixture using an igniter, such as a spark plug, laser igniter and/or other type of igniter. Typical internal combustion engine igniters must be replaced often because of their short life span. The short life span of igniters can be attributed, in large part, to their electrode erosion over time that results in an increased voltage needed to initiate an ignition event. To compensate for erosion, energy supplied to the igniter in engine systems is often set at a high enough level to ensure reliable ignition over the expected life of the igniter, thereby accounting for some eventual erosion without impacting performance.

Prior art attempts at increasing the useful life of igniters include ignition systems varying the voltage of the current directed to the spark plug, short circuiting the primary ignition coil after combustion has initiated, adjusting spark duration by measuring the primary coil rise time, and reducing coil dwell until misfire occurs to determine a lowest acceptable spark energy for good combustion.

### DESCRIPTION OF DRAWINGS

FIG. 1 is a schematic of a cylinder of an internal combustion engine including a control system.

FIG. 2 is a schematic of an ignition system with a control module.

FIG. 3 is a flow chart of the operation of the engine control module of FIG. 2.

FIG. 4 is a flow chart of the operation of the ignition control ASIC of FIG. 3.

FIG. 5 is a graph of voltage vs. time for an ignition coil during an ignition event.

FIG. 6 is a graph of voltage vs. time for an ignition coil during a shorter ignition event.

FIG. 7 is a graph of voltage vs. time for an ignition coil during a longer ignition event.

FIG. 8 is an example lookup table of target spark duration with respect to intake manifold pressure and engine speed.

Like reference symbols in the various drawings indicate like elements.

### DETAILED DESCRIPTION

Generally, spark plug life is a function of the energy discharged in the spark. There are other variables to consider, but they are independent of the control system (i.e. electrode materials, combustion temperature, etc.). As energy increases in the spark, the electrode erosion rate also increases, which decreases spark plug life. Erosion widens the spark gap and increases the required voltage. Moreover, if the voltage required for a spark event goes above a supply voltage from the Secondary coil, the spark plug may fail to generate a spark and result in an engine-damaging misfire event.

Spark energy is a function of inductive coil primary dwell time and secondary voltage. The required energy also varies with the operating conditions. As primary dwell increases there is more energy available in the coil for the spark. That energy is first used to initiate the spark across the gap by generating a high voltage and the remainder of the energy is discharged as current flowing through the spark. It is during this second stage where spark plug electrode erosion occurs. When the energy is no longer sufficient to maintain the spark across the gap, the spark will collapse and the remaining energy in the coil is discharged through a secondary circuit. The time from the beginning of the spark to the collapse is referred to as secondary duration or spark duration. For a given engine speed/load operating point, a fixed amount of secondary duration is required to initiate stable combustion in the cylinder. Secondary duration beyond that required for stable combustion provides no increase in performance and is regarded as wasted energy and the electrodes are eroded unnecessarily. Also, as the spark plug ages and the gap widens, additional energy is needed to initiate the spark, so the system can compensate the coil energy over time to maintain the target secondary duration for combustion.

Typical ignition control systems do no not directly measure or control spark duration. Instead, some measure primary coil rise time which indicates various operating parameters and thereafter determine an “ignition duration” that is suitable. The ignition duration is the time that the system is providing energy to the ignition coil. In these prior art system, the result of the chosen ignition duration is a spark duration that avoids excessive electrode erosion. Essentially, many existing systems employ an open-loop control of spark duration. Advantageously, examples of the present system include directly measuring spark duration and controlling primary ignition coil dwell to maintain a target spark duration.

Examples of the present system include dynamically changing primary dwell to achieve a target spark duration in response to current engine operational parameters. Some examples of the present system include directly measuring the spark duration by monitoring the voltage reflection on the primary side of the coil. The target spark duration may be determined during development and, in some instances, is fixed throughout the life of the engine.

Examples of the present system have a current rise on the primary coil and when the current flow is stopped rapidly the voltage will rise. Due to the windings in the coil the voltage on the secondary side will increase even more, which creates the spark. The spark discharges most of the energy in the coil and the ignition event will end when the energy is not sufficient to maintain the spark. Examples of the present system include inductive devices. Existing capacitive systems maintain the spark by modulating the current on the primary side of the coil.

Many prior art systems exist for reducing spark plug wear, however, the failure mechanism addressed by some existing system are caused by “blowouts” and “rearcs,” which are common in certain types of engines. While not excluded from the ability of the present system, some examples described herein advantageously address erosion caused by normal current flow in the spark during an engine ignition event.

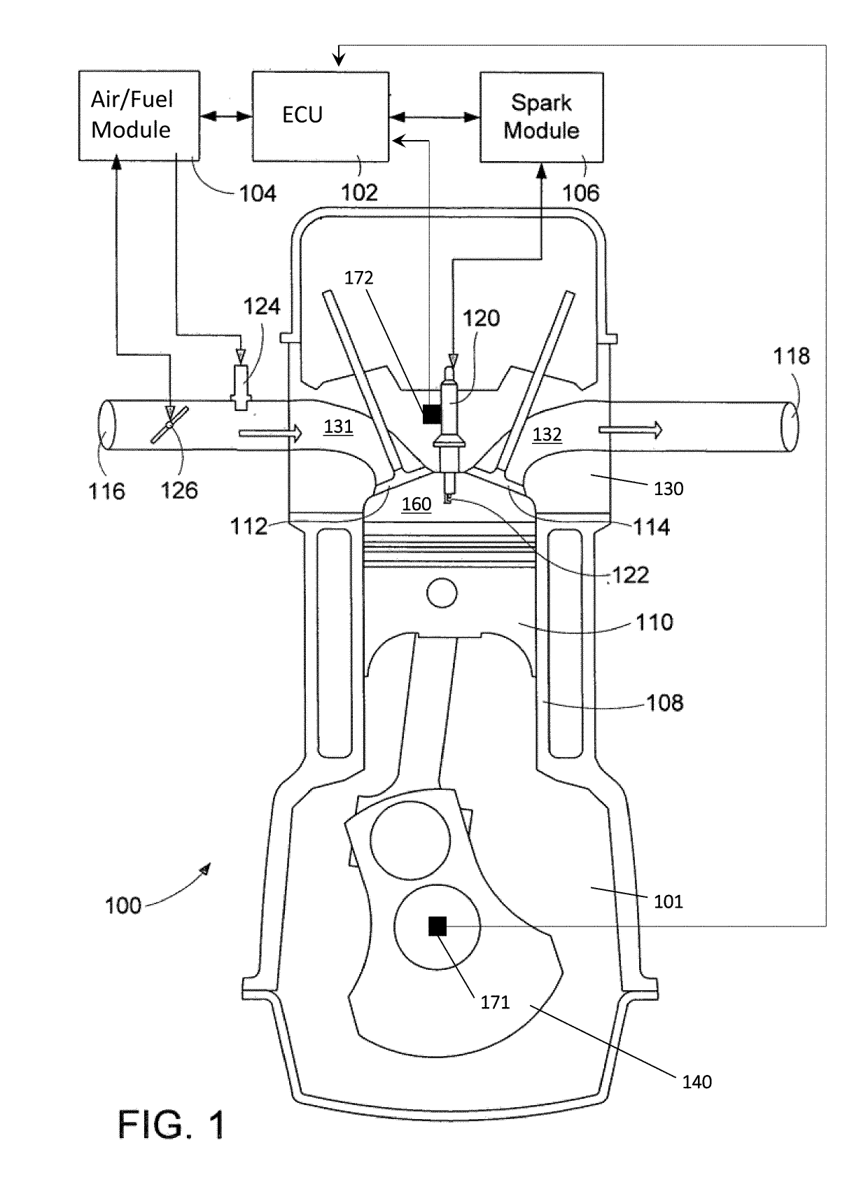

Referring initially to FIG. 1, an engine system 100 exemplifying the present system is shown. The engine system 100 includes an engine control unit 102, an air/fuel module 104, a spark module 106, and a reciprocating engine block 101. FIG. 1 illustrates, for example, an internal combustion engine 100. For the purposes of this disclosure, the engine 100 will be described as a gaseous-fueled engine, for example a natural gas engine. One skilled in the art will recognize that the engine may be any other type of combustion engine such as, for example, a gasoline-fueled engine. While the engine control unit 102, the air/fuel module 104 and the spark module 106 are shown separately, it is recognized that the modules 102, 104, 106 may be combined into a single module or be part of an engine controller having other inputs and outputs.

The reciprocating engine 101 includes engine cylinder 108, a piston 110, an intake valve 112 and an exhaust valve 114. The engine 101 includes an engine block that includes one or more cylinders 108 (only one shown in FIG. 1). The engine 100 includes a combustion chamber 160 formed by the cylinder 108, the piston 110, and a head 130. A spark plug 120 is positioned within the head 130 such that a spark gap 122 of the spark plug 120 is positioned within the combustion chamber 160. In some instances, the spark gap 122 is an arrangement of two or more electrodes with a small space in-between. When an electric voltage is applied to one of the electrodes, an electric arc is created that bridges the small space (i.e., the spark gap) between the electrodes. The piston 110 within each cylinder 108 moves between a top-dead-center (TDC) position and a bottom-dead-center (BDC) position. The engine 100 includes a crankshaft 140 that is connected each piston 110 such that the piston 108 moves between the TDC and BDC positions within each cylinder 108 and rotates the crankshaft 140. The TDC position is the position the piston 110 with a minimum volume of the combustion chamber 160 (i.e., the piston's 110 closest approach to the spark plug 120), and the BDC position is the position of the piston 110 with a maximum volume of the combustion chamber 160. (i.e., the piston's 110 farthest retreat from the spark plug 120).

The cylinder head 130 defines an intake passageway 131 and an exhaust passageway 132. The intake passageway 131 directs air or an air and fuel mixture from an intake manifold 116 into combustion chamber 160. The exhaust passageway 132 directs exhaust gases from combustion chamber 160 into an exhaust manifold 118. The intake manifold 116 is in communication with the cylinder 108 through the intake passageway 131 and intake valve 112. The exhaust manifold 118 receives exhaust gases from the cylinder 108 via the exhaust valve 114 and exhaust passageway 132. The intake valve 112 and exhaust valve 114 are controlled via a valve actuation assembly for each cylinder, which may be electronically, mechanically, hydraulically, or pneumatically controlled or controlled via a camshaft (not shown).

Movement of the piston 110 between the TDC and BDC positions within each cylinder 108 defines an intake stroke, a compression stroke, a combustion or power stroke, and an exhaust stroke. The intake stroke is the movement of the piston 110 away from the spark plug 120 with the intake valve 112 is open and a fuel/air mixture being drawn into the combustion chamber 160 via the intake passageway 131. The compression stroke is movement of the piston 110 towards the spark plug 120 with the air/fuel mixture in the combustion chamber 160 and both the intake valve 112 and exhaust valve 114 are closed, thereby enabling the movement of the piston 110 to compress the fuel/air mixture in the combustion chamber 160. The combustion or power stroke is the movement of the piston 110 away from the spark plug 120 that occurs after the combustion stroke when the spark plug 120 ignites the compressed fuel/air mixture in the combustion chamber by generating an arc in the spark gap 122. The ignited fuel/air mixture combusts and rapidly raises the pressure in the combustion chamber 160, applying an expansion force onto the movement of the piston 110 away from the spark plug 120. The exhaust stroke is the movement of the piston 110 towards the spark plug 120 after the combustion stroke and with the exhaust valve 114 open to allow the piston 110 to expel the combustion gases to the exhaust manifold 118 via the exhaust passageway 118. In some instances, the engine 100 is a 2-stroke engine completing a power cycle of the engine 100 during only one crankshaft 140 revolution.

The engine 100 includes a fueling device 124, such as a fuel injector, gas mixer, or other fueling device, to direct fuel into the intake manifold 116 or directly into the combustion chamber 160. In some instances, the fuel includes a compressed gaseous fuel such as natural gas or propane. In some instances, the fuel is a liquid, for example, gasoline.

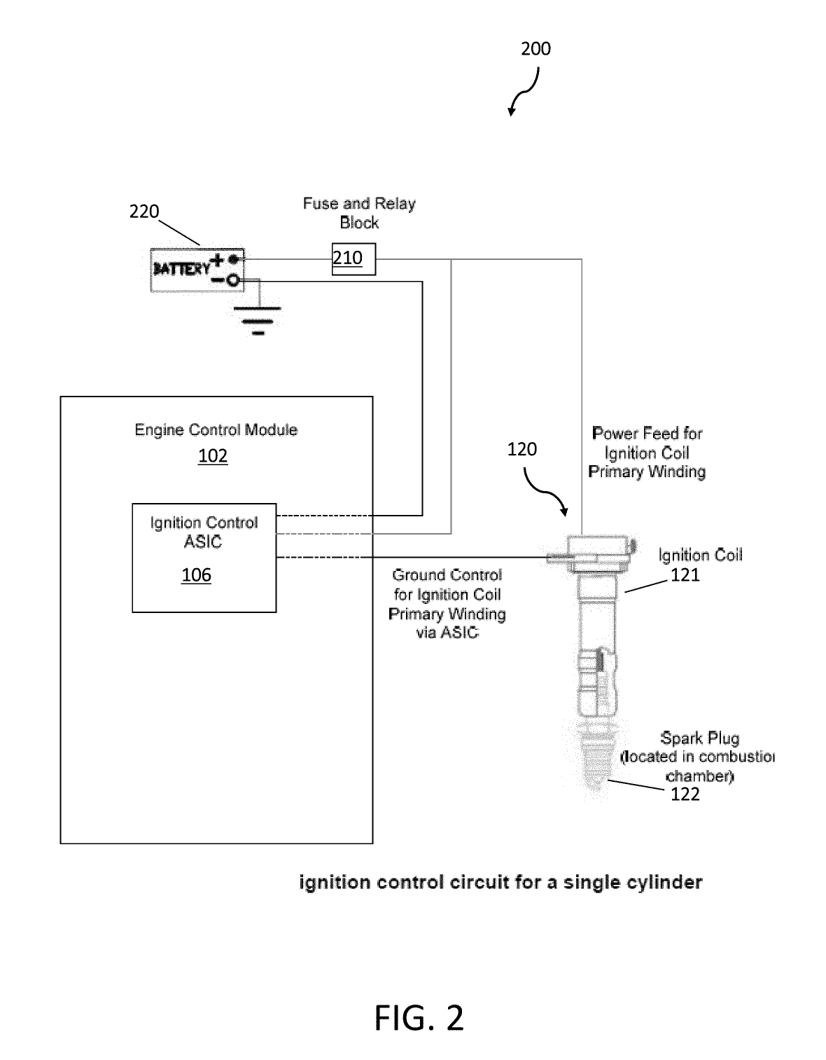

During operation of the engine, i.e., during a combustion event in the combustion chamber 160, the air/fuel module 104 supplies fuel to a flow of incoming air in the intake manifold before entering the combustion chamber 160. The spark module 106 controls the ignition of the air/fuel in the combustion chamber 160 by regulating the timing of the creation of the arc the spark gap 122, which initiates combustion of the fuel/air mixture within combustion chamber 160 during a series of ignition events between each successive compression and combustion strokes of the piston 110. During each ignition event, the spark module 106 controls ignition timing and provides power to the primary ignition coil of the spark plug 120. The air/fuel module 104 controls the fuel injection device 124 and may control throttle valve 126 to deliver air and fuel, at a target ratio, to the engine cylinder 108. The air/fuel module 104 receives feedback from engine control module 102 and adjusts the air/fuel ratio. The spark module 106 controls the spark plug 120, by controlling the operation of an ignition coil electrically coupled to the spark plug and supplied with electric current from a power source (both shown in FIG. 2). The ECU 102 regulates operation of the spark module 106 based on the engine speed and load and in addition to aspects of the present system disclosed below.

In some instances, the ECU 102 includes the spark module 106 and the fuel/air module 104 as an integrated module with software algorithms executed by a processor of the ECU 102, and thereby operate of the engine as single hardware module, in response to input received from one or more sensors (not shown) which may be located throughout the engine. In some instances, the ECU 102 includes separate software algorithms corresponding to the described operation of the fuel/air module 104 and the spark module 106. In some instances, the ECU 102 includes individual hardware module that assist in the implementation or control of the described functions of the fuel/air module 104 and the spark module 106. For example, the spark module 106 of the ECU 102 may include an ASIC (shown in FIG. 2) to regulate electric current delivery to the ignition coil (also shown in FIG. 2) of the spark plug 120. One skilled in the art can appreciate that a plurality of sensor systems exist to monitor the operational parameters of an engine 100. For example, a crank shaft sensor, an engine speed sensor, an engine load sensor, an intake manifold pressure sensor, an in-cylinder pressure sensor, etc. Generally, these sensors generate a signal in response to an engine operational parameter. For example, a crank shaft sensor 171 reads and generates a signal indicative of the angular position of crankshaft 140. In an exemplary embodiment, a voltage sensor 172 sensor measures voltage reflections on the primary side of at the ignition coil (shown as 121 in FIG. 2) during a spark event occurring at the spark gap 122 during an ignition event. The sensors 171,172 may be directly connected to the ECU 102 to facilitate the sensing. In some instances, the ignition control described herein is a stand-alone ignition control system providing the operation of ECU 102 and the spark module 106. In certain instances, the sensor may be integrated into one of the control modules, such as the ECU 102 or the spark module 106. Other sensors are also possible, and the systems described herein may include more than one such sensor to facilitate sensing the engine operational parameters mentioned above.

For example, an example of the present system to reduce the spark plug erosion includes a Woodward® OH6 engine control system that has been modified to control the energy delivered to an ignition to coil to the minimum necessary for stable combustion, and, in some instances, with a margin, for all engine operating modes over the life of the engine. Example implementations control the electric current that is stored in the primary stage of the ignition coils of the spark plug 120. In some instances, the present system eliminates a need to discharge any excess energy that is not needed for combustion.

In some instances, the engine 100 could be another type of internal combustion engine that doesn't have pistons/cylinders, for example, a Wankel engine (i.e., a rotor in a combustion chamber). In some instances, the engine 100 includes two or more spark plugs 120 in each combustion chamber 160.

One example system schematic for a single cylinder is shown in FIG. 2. The ignition system 200 includes an engine control unit 102 with a processor 106. In certain instances, and in this example of the system, the processes is an ASIC 106 (application specific integrated circuit) configured to control the delivery of current to the ignition coil of a spark plug 120 and to measure the secondary duration via voltage reflections on the primary side of the ignition coil. This ASIC 106 is commonly used in light-duty automotive applications and the measurements made by the ASIC 106 are typically used for diagnostic purposes only to satisfy OBD regulations. In some instances, the ASIC is a MC33180. The connections between the ignition coil and the engine control module 102 and the corresponding internal connections to the ASIC 106 are shown in FIG. 2. The ASIC 106 controls the primary ignition coil 121 current by connecting the negative side of the ignition coil 121 to ground and disconnecting the ground when the current has reached a pre-determined level defined by the software of the engine control unit 102. During the charging and discharging process of the primary ignition coil 121, the ASIC 106 monitors the voltage waveform coming from the ignition coil 121 and determines various ignition parameters including secondary duration (i.e., spark duration).

FIG. 2 is a schematic of an ignition system 200 with an engine control module 102. An engine control system 200 includes a look up table of a target secondary duration (e.g., a target spark duration) for the given engine application. A power supply 220 may be operably connected to the ECU 102 and configured to supply energy to one or more components of the ignition system 200 and/or other engine components discussed herein. The power supply, in certain instances, is a constant voltage direct current source, such as a battery or similar device. The power supply 220 may be the battery of the vehicle to which the engine system 100 is connected. In some instances, the power supply 220 is an alternating current source of electrical energy. In some instances, the power supply 220 is separate from the battery and may be, for example, a dedicated power supply to the ignition system 200. In some instances, the power supply 220 supplies a direct current to a fuse block and relay system 210 that supplies current to both the ECU 102 and the primary winding of the ignition coil 121. During duration operation of the engine system 100 by the ignition system 200, the voltage supplied across the spark gap 122 of the spark plug 120 results in a spark that causes ignition of the fuel and air mixture within combustion chamber 160 during each ignition sequence event. In some instances, the primary voltage is between 6 and 36 volts and the primary coil is charged with a current of between 2 to 10 amps.

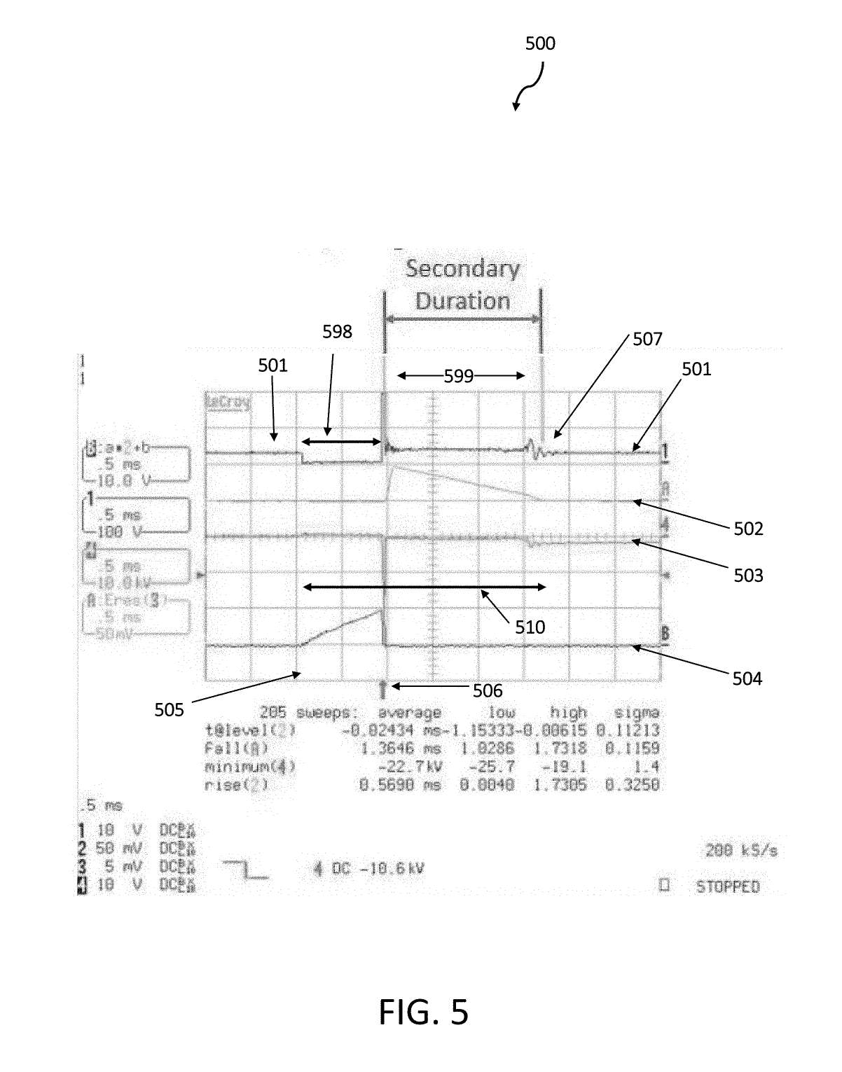

The primary ignition coil 121 of the park plug 120 is operatively connected to the ECU 102 and is configured to provide a voltage across the spark gap 122 in response to current supplies from the power source 220. The primary ignition coil 121 may be a separate component of the ignition system 200 or integrated with the spark plug 120 or other electrical components of the ignition system 200. The primary coil of the spark plug is energized when the ASIC 106 directs an electric current from the power supply 220 directing to the ignition coil 53 at a commanded voltage. The primary ignition coil 121 may include an inductor configured to store energy until the ASIC commands that the energy is controllably released across the spark gap 122. In some instances, the energy storage and discharge of the primary ignition coil result in the characteristics of the waveforms illustrated in FIG. 5. In some instances, the ignition coil 121 includes a capacitor configured to store the minimum energy needed to initiate combustion according to aspects of the present system.

The ECU 102 may include one or more microprocessors for controlling the operation of the engine system 100. In certain instances, the microprocessors can include an application specific integrated circuit (ASIC). FIG. 2 shows the ECU 102 including an ASIC 106 configured to control current delivery to the primary ignition coil 121 of the spark plug 120. In some instances, the ECU 102 controls the ignition coil 121 in response to signals received from the voltage sensor 172 that directly measure the voltage reflection on the primary side of the ignition coil 121. Some examples of the disclosed ignition system 200 are applicable to any combustion engine where reduced spark plug 120 electrode erosion is target, particularly in the case of natural-gas engines. Examples of the present system include operation of the ignition system 200 to reduce electrode erosion and/or provide control over spark duration in response to direct measure of the voltage reflection on a primary side of the ignition coil 121 (indicating the spark duration during each ignition event). As is known in the art, electrode erosion is aggravated during an ignition sequence when the spark duration is longer than necessary to provide for ideal combustion during each combustion event. That is, a spark has been formed in the spark gap 122 of the spark plug 120 when the primary coil 121 is charged and the combustion has fully unitized, but electrical current continues to flow between the spark gap 122 and generates a spark duration longer than necessary.

As shown herein, direct measurement of the spark duration enables the ignition system 200 to modulate the primary coil dwell set point to adjust the spark duration to a target spark duration, based on, for example, a look up table of target spark duration based on one or more received engine operational parameters. It is believed that excess spark energy (i.e., beyond what is necessary for achieving a target spark duration and/or target combustion metrics) results in excess wear and erosion of the electrodes at the spark gap 122 of the spark plug 120. Excess electrode erosion results in a reduction in the useful life of the spark plugs 120. In certain instances, examples of the present disclosure are useful in increasing the lifespan of the spark plug 120 by dynamically controlling the primary coil dwell set point to achieve a target spark duration, which, in some instances, minimizes the excess spark energy associated with each ignition event

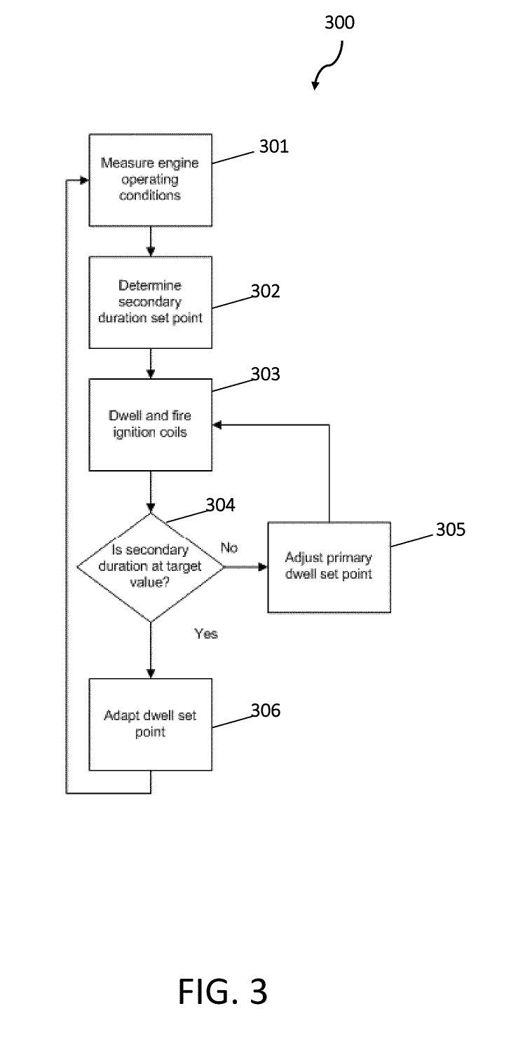

The engine control system 200 is, in some instances, an OH6 engine control system made by Woodward. The engine control system 200 will fire the coils 121 of the spark plug 120 as the engine system 100 is running and adjust the primary coil dwell current set point until the target secondary duration is reached. When the secondary duration set point is reached the system will adapt the dwell set point. A flow chart showing an example of the spark duration control logic is shown below in FIG. 3.

FIG. 3 is a flow chart of the operation of the engine control module. The engine control unit 102 continuously measures 301 engine operation parameters (i.e., engine condition variables or operating conditions). In some instances, the measured operation parameters include engine speed, engine load, manifold pressure, measured spark duration via voltage reflection on the primary side of the ignition coil 121 (as detailed above), or in-cylinder pressure. Those skilled in the art will appreciate that any engine parameter relating to the operational conditions of the engine could be received by the engine control unit 102 during use and used in the following steps. Using the measured engine operation parameters, the engine control unit 102 determines 302 a secondary duration set point (i.e., a target spark duration). In some instances, the determining 302 includes using the received engine operational parameters as inputs for a look up table that returns a target spark duration. In some instances, the secondary duration look-up table contains secondary duration set points for the engine as a function of engine speed and intake manifold pressure. Other engine operating conditions may be modifiers to the secondary duration set point. In some instances, the values in the lookup table are determined experimentally on the engine by varying the coil primary current and collecting engine performance and combustion data in addition to secondary duration data. In those instances, given the experimental data, a correlation is made between the performance and combustion data and the measured secondary duration for each engine operating point in the table. A target secondary duration is chosen from each correlation that provides adequate engine and combustion performance. Those values are entered into the lookup table. The engine is further tested on the dynamometer and/or vehicle to ensure acceptable performance at the system level.

In some instances, the look up table contains a predetermined list of target spark durations as a function of (or simply corresponding to) the operational parameters of the engine. In some instances, the lookup table is created during engine testing and prior to deployment of the engine 100. The lookup table can also store the most-recent coil dwell that achieved the target coil dwell. In this fashion, the lookup table adapts to spark plug wear that can increase the necessary coil dwell to achieve a given spark duration as the spark plug wears. In some instances, the determining 302 returns a primary coil dwell set point that corresponds with the determined target spark duration. Is not necessary to store the coil dwell set point, but it is beneficial. In some instances, storing an adapted primary dwell set point enables the system to reach a reduced coil energy in less time each time the engine is started and aspects of the present system are enabled.

The ECU 102 implements 303 the determined set point by supplying current to the primary side of the ignition coil 121 of an ignition device (i.e., spark plug 120) during a combustion event. During the combustion event, the ECU 102 directly calculates 304 the secondary duration (i.e., the actual spark duration of the ignition event) by sensing the voltage reflection of the primary side of the ignition coil 121 and compares the calculated value to the target spark duration. Based on the comparison, the ECU 102 adjusts 305 the primary coil dwell set point associated with the target spark duration or adapts 306 the primary coil dwell set point. Adapting 306 the primary coil dwell set point, in some instances, includes storing the adapted value in the lookup table. Adjusting 305 the primary coil dwell set point, in some instances, includes incrementally increasing the primary coil dwell. In some instances, the magnitude of the increase is a function of the comparison between the target and actual spark duration. In some instances, adjusting the primary dwell set point also is incrementally decreasing the set point. This may be the case if the adaptive learned values are reset, if a fault condition existed, but was cleared, that reset the adaptive table, or if new spark plugs were installed in the engine.

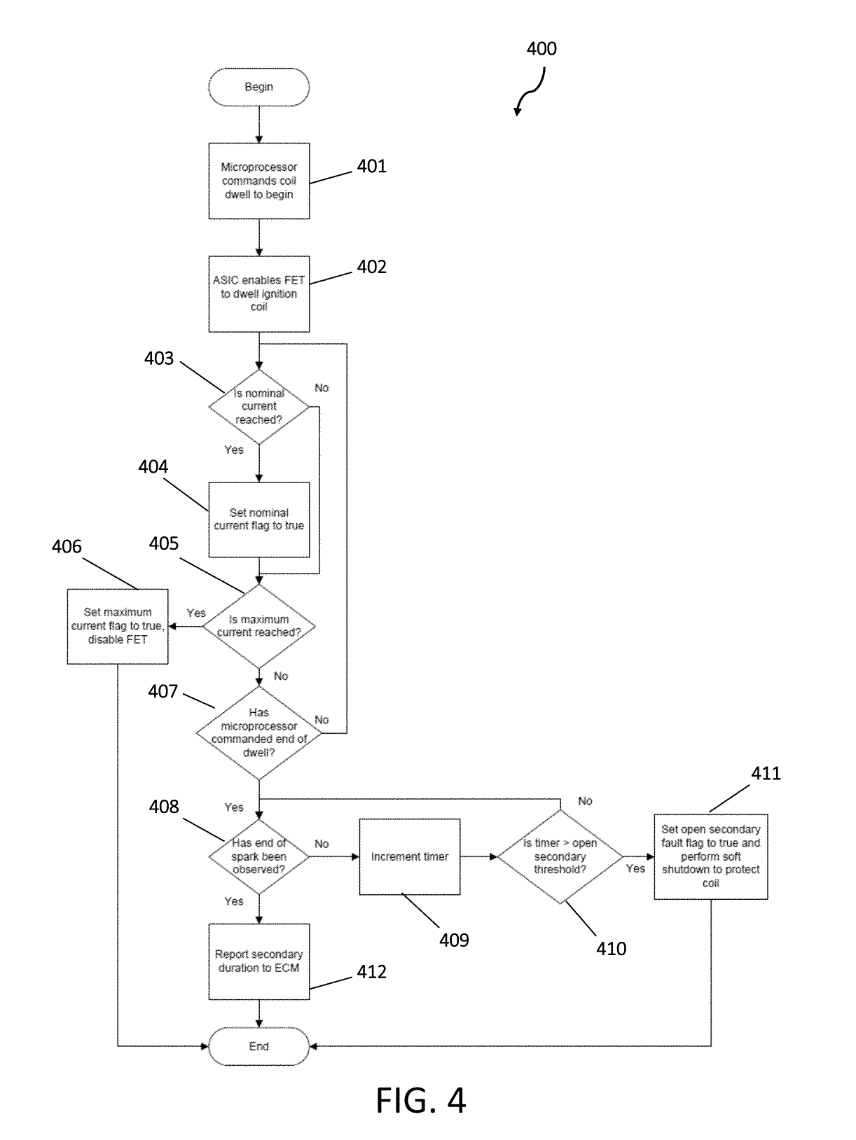

FIG. 4 is a flow chart of the operation of the ignition control ASIC 106 of FIG. 2. The ASIC 106 is configured to initialize and fire the primary ignition coil 121 during an ignition event, while measuring the voltage reflections on the primary side of the coil 121 to enable the ECU 102 to calculate the spark duration. To begin, the ECU 102 commands 401 the ASIC 106 to initialize the primary coil dwell. In response, the ASIC 106 enables 402 a field-effect transistor (FET) to dwell the ignition coil 121 by flowing current to the primary ignition coil 121. During this time, the ASIC 106 monitors 403 the current and, if a nominal current is reached, sets 404 a nominal current flag to true. Else, the ASIC 106 checks 405 to see if the maximum current has been reached. If the maximum current is reached, the ASIC 106 sets 406 the maximum current flag to true and disables the FET, thus ending the primary coil dwell. The flags are used for other functions outside of this invention. The “nominal current” flag is used for feedback in the subsystem that adaptively controls primary dwell time. The system also uses it for diagnostic purposes (i.e. if the flag is never present then there may be an open circuit on the primary side of the coil). The “maximum current” flag is used to diagnose short circuit conditions in the primary side of the coil. If the maximum current is not reached, the ASIC 106 checks 407 to see if the ECU 102 has commanded the end of the primary coil dwell. If the ECU 102 has not, then the FET continues to supply current to the primary ignition coil 121 and the ASIC 106 return to monitor 403 the supplied current. Once the ECU 102 has commanded the dwell to end, the ASIC 106 determines 408 if the end of the spark has been observed. If the spark is determined to be completed in the spark plug 120, the ASIC 106 reports 412 the spark duration to the ECU 102 and completes the ignition event. If the end of the spark is not observed, the ASIC 106 increments 409 a timer and checks 410 if the timer value is greater than an open secondary (spark duration) threshold. If not, the ASIC 106 continues to check 408 for the end of the spark and increment 409 the timer. The timer is used by the system to diagnose an open circuit on the secondary side of the ignition coil 121 (i.e. the coil is not connected to the spark plug or there is an issue with the ignition coil windings), or if there is insufficient energy to jump in the ignition coil 121 to jump the gap. The logic in the system is: If the timer is greater than threshold, then a secondary fault is indicated. Therefore, if the timer value reaches the open secondary threshold, the ASIC 106 sets 411 an open secondary flag to true and performs a soft shutdown to protect the ignition coil 121. When the ASIC 106 sets the open secondary flag, the system indicates there is an issue with the hardware and the energy in the ignition coil 121 cannot be discharged in the intended fashion through the spark plug. Subsequently, the ASIC 106 will drain the stored energy back to the battery via the primary side of the ignition coil 121 to prevent damage to the ignition coil and other system components and to prevent any potential safety issues that could be caused by a high voltage present on the secondary side of the ignition coil.

In some instances, the algorithm of FIG. 4 is be carried out with a main microprocessor and the basic hardware is assembled in the ECM that would replace the function of the ASIC hardware.

In some instances, a PID control may be used to control the coil dwell to obtain the desired secondary duration. In other instances, an error accumulator controller that slowly increments or decrements the coil dwell is used. The present systems are independent of the type of controller used to adjust primary coil dwell. In some instances, an accumulator type is chosen because of the ease of implementation and calibration, but one skilled in the art can appreciate that others may be suitable as well.

FIG. 5 shows the results of a test conducted to illustrate the relevant signals in an inductive ignition system. FIG. 5 shows that spark duration 599 and secondary breakdown voltage are directly related. Specifically, FIG. 5 shows the voltage 501 observed on the low side of the primary coil relative to battery ground, the current 502 flowing through the secondary coil windings, the inverse 503 of the voltage measured at the low-side of the secondary coil, and the current 504 flowing through the primary coil windings. Range 598 is defined as the primary dwell time where the energy is being added to the coil by allowing current to flow from the battery through the coil to ground. Range 599 is defined as the spark time or spark duration. This range 599 is when the spark is present in the spark plug gap. Energy stored in the coil is being discharged to ground through the spark in the spark plug gap 122. For a given primary dwell 598 current 504 the spark duration 599 decreases with increase secondary breakdown voltage 502. As the spark plug gap 122 widens, high breakdown voltages 502 are required to jump the gap 122. When the spark plugs 120 are new, low voltages are required to jump the gap 122 and much of the energy in the coil 121 is dissipated in the spark. There is a fixed amount of spark duration 599 required for reliable ignition for a given operating point, and any additional spark duration is unnecessary and results in excessive electrode erosion. Examples of the present system measure and control spark duration, thus enabling the system to limit excess duration and, in certain instances, reduce and/or minimize electrode erosion.

FIG. 5 illustrates a time-series of events representing one firing of the ignition coil. During an ignition event 510, the spark plug 120 creates a spark starting at the time 506, and, in some instances, the spark is maintained in the spark gap 122 for a spark duration 599 lasting the remainder of the ignition event 510. However, the secondary duration 599 may be longer than is necessary to promote adequate combustion within the combustion chamber 160 based on a determination of a target spark duration, as discussed above. At time 505 the low-side of the primary coil is shorted to ground as indicated by the falling edge of curve 501. This permits the current to begin flowing into the primary windings as indicated by the increase in curve 504. This initiates the dwell period represented as 598 in the figure. When the desired primary current value has been reached the system creates an open circuit between the low-side of the primary coil and ground. Because of the inductance of the coil rapidly opening the circuit will result in a voltage spike on the primary coil. The peak of the spike is on the order of 200-300 VDC. This is observed in curve 501 as the voltage spike at time 506. This voltage 501 will be reflected to the secondary side of the coil and is observed as the voltage spike on curve 503 at time 506. The peak of the voltage is approximately 15-35 kV. This large voltage allows electrons to jump the gap 122 in the spark plug 120 and initiate current flowing through the secondary coil windings discharging the energy stored in the coil 121. When the energy remaining in the coil is insufficient to maintain the spark, the spark will collapse and the voltage on the secondary side of the coil 121 will fluctuate and can be observed in curve 503. The fluctuation will be reflected onto the primary side of the coil and can be observed in the coil voltage 501 at the end of duration 599. This voltage fluctuation is the result of residual energy in the coil being dumped back to the battery 220 via the electrical connection to the coil 121.

For example, with respect to the ignition coil current waveforms of FIG. 5, the primary coil dwell 598 of a given ignition event is be measured from the initial time 505 that a flow of electrical current is sent to the primary ignition coil 121 until a stop time 506 (when the flow of current is stopped). The primary coil dwell 598 is the length of time during which current 504 is directed to a primary winding of the ignition coil 121. As shown in FIG. 5, the primary coil dwell 598 may be shorter than a corresponding spark duration 599 (the length of time during which a resulting spark is generated at the spark gap 122). The secondary duration 599 is not necessarily longer than the primary dwell 598. In FIG. 5, the secondary duration 599 is longer than the primary dwell time 598 because the data 500 was taken on a bench with relatively low combustion chamber pressure. The energy required to initiate the spark was relatively low, therefore a lot of energy was discharged through the spark, giving a longer than normal spark duration 599. In some instances, the length of the dwell time is mostly dependent on the ignition coil construction (i.e., inductance) and battery voltage. In some instances, the spark duration is not necessarily related to the primary coil dwell time, but is instead related to the primary dwell current and secondary breakdown voltage for a given ignition coil. Thus, for a given condition, the primary dwell or the secondary duration may be longer than the other.

Embodiments of the present system measure the secondary duration 599 and control the primary coil dwell 598 to adjust the secondary duration 599 based on a target secondary duration 599 that is determined using the engine's 100 operational parameters. Examples of the present system may reduce or increase the primary coil dwell based on the measured secondary duration 599. By dynamically controlling the primary coil dwell 598 to achieve a target secondary duration 599, examples of the present system can, for each ignition event, reduce excess electrode erosion adjusting the current sent to the primary ignition coil 121. This adjustment enables the ignition system 200 to limit the primary coil dwell 598 to a time amount necessary to achieve the target spark duration 599.

As shown in FIG. 5, the electrical current 504 sent to the ignition coil 120 may rise substantially steadily beginning from the start time 505 through the end time 506. In some instances, the flow of current sent to the ignition coil 121 increases until a threshold current is reached. Upon reaching the threshold, the ECU 102 stops current from flowing to the ignition coil 121. The ECU 102 measures the primary coil dwell 598, which varies based on, for example, engine load, in-cylinder pressure, and other operational parameters of the engine 100. The primary coil dwell 505 increases with wear of the engine 100 because, for example, erosion in older spark plugs 120 increase the spark gap 122 and increases the primary coil dwell necessary to achieve a given spark duration 599.

FIG. 5 also illustrates how an ASIC 106 in the ECM 102 directly measures the voltage reflection in primary coil. Curve 501 is the voltage on the low-side of the primary coil. During the dwell period 598 the low-side of the primary coil is shorted to ground, initiating current to flow into the coil 121. When the desired primary current 504 is reached the low-side of the coil is opened to ground (i.e. open circuit. This causes a high voltage on the primary side of the coil (spike in the curve at time 506). Given the greater number of turns in the secondary side of the coil an even larger voltage is created in the secondary which in turn jumps the gap 122 to initiate the spark. The energy stored in the coil flows out through the secondary side of the coil until the spark collapses (end of 599). When the spark collapses there is a voltage ripple which can be observed on the primary side of the coil. This is shown in FIG. 5 the end of duration 599 as a fluctuation 507 in voltage 501. This voltage fluctuation 507 (i.e., ripple) is the result of the residual energy stored in the coil 121 being dumped back to the battery 220 via the electrical connection between the coil and the battery. The ASIC 106 monitors the primary coil voltage 501 and triggers on the two voltage variations that at the beginning and end of the spark event. The time between the two voltage variations is defined as the secondary (or spark) duration 599.

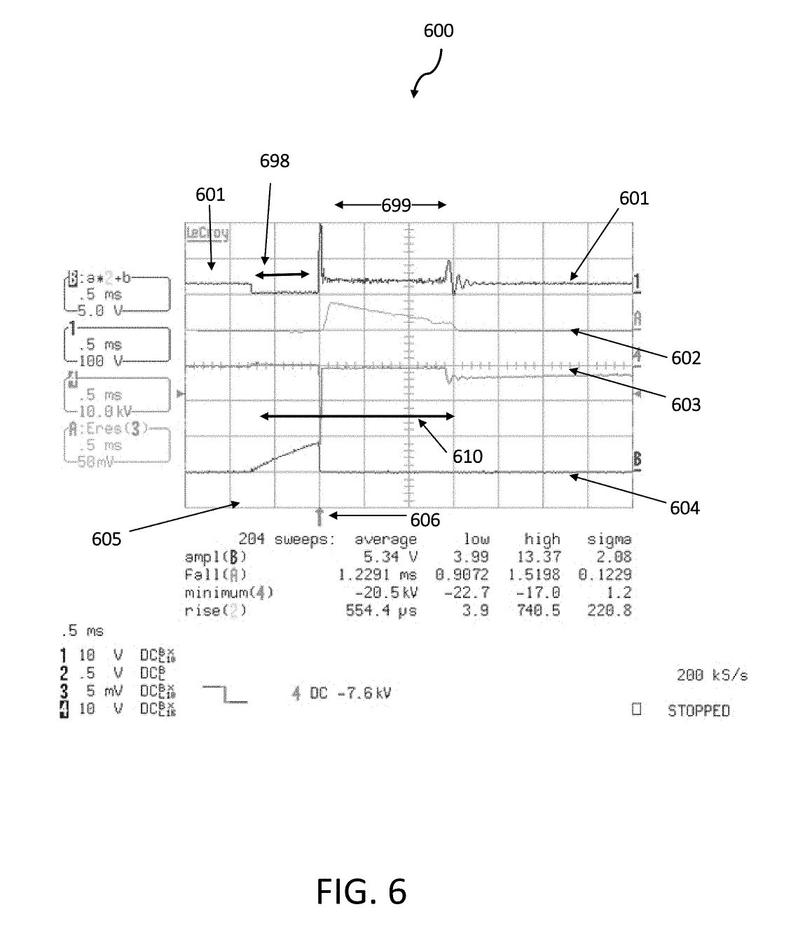

FIG. 6 is a graph 600 of voltage vs. time for an ignition coil during a shorter ignition event. FIG. 6 shows the voltage 601 observed on the low side of the primary coil relative to battery ground, the current 602 flowing through the secondary coil windings, the inverse 603 of the voltage measured at the low-side of the secondary coil, and the current 604 flowing through the primary coil windings. Range 698 is defined as the primary dwell time where the energy is being added to the coil by allowing current to flow from the battery through the coil to ground. Range 699 is defined as the spark time or spark duration. This range 699 is when the spark is present in the spark plug gap 122. Energy stored in the coil is being discharged to ground through the spark in the spark plug gap. At time 605 the low-side of the primary coil is shorted to ground as indicated by the falling edge of curve 601. This permits the current to begin flowing into the primary windings as indicated by the increase in curve 604. This initiates the dwell period represented as 698 in the figure. The dwell period 698 is 0.554 ms and the resulting secondary duration 699 is 1.229 ms.

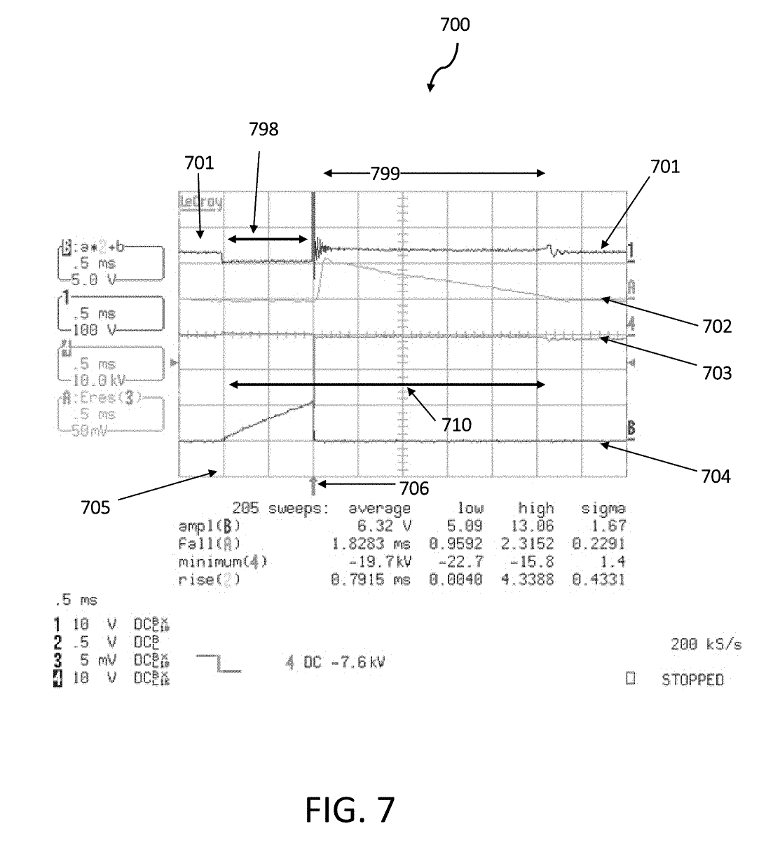

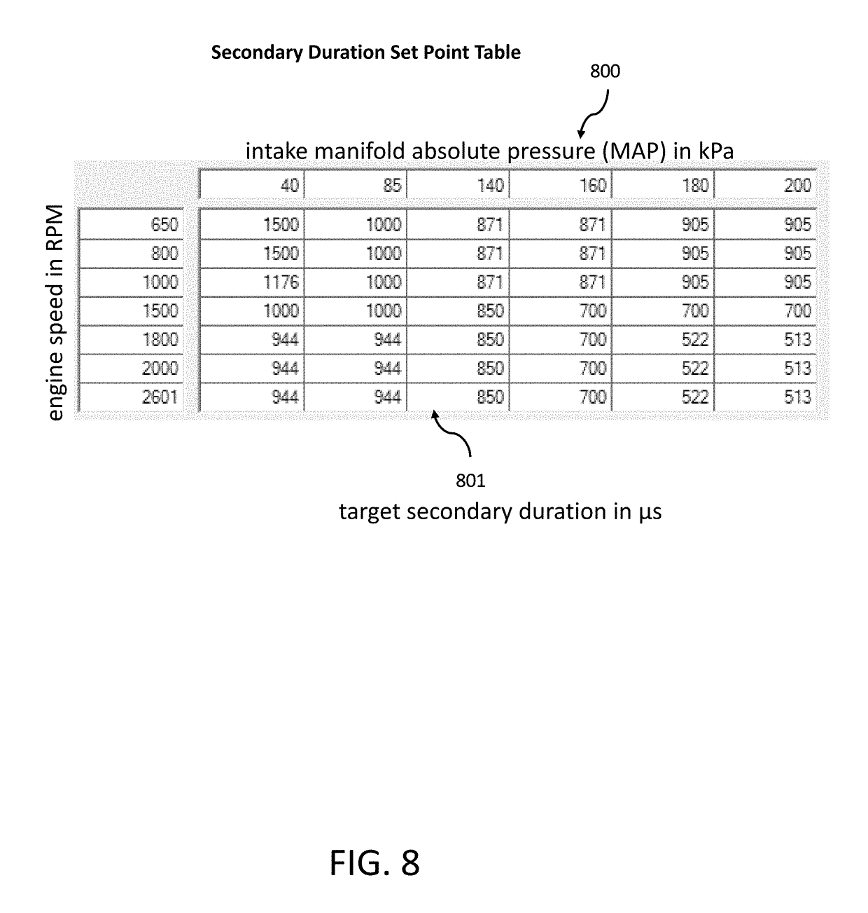

FIG. 7 is a graph 700 of voltage vs. time for an ignition coil during a longer ignition event. FIG. 7 shows the voltage 701 observed on the low side of the primary coil relative to battery ground, the current 702 flowing through the secondary coil windings, the inverse 703 of the voltage measured at the low-side of the secondary coil, and the current 704 flowing through the primary coil windings. Range 798 is defined as the primary dwell time where the energy is being added to the coil by allowing current to flow from the battery through the coil to ground. Range 799 is defined as the spark time or spark duration. This range 799 is when the spark is present in the spark plug gap 122. Energy stored in the coil is being discharged to ground through the spark in the spark plug gap. At time 705 the low-side of the primary coil is shorted to ground as indicated by the falling edge of curve 701. This permits the current to begin flowing into the primary windings as indicated by the increase in curve 704. This initiates the dwell period represented as 798 in the figure. The dwell period 798 is 0.792 ms and the resulting secondary duration 699 is 1.828 ms. FIGS. 6 and 7 illustrate an ability to modulate the coil dwell period 698, 798 and measure the resulting secondary duration 799, 699. In this manner, examples of the present system control use a look up table, such as the set point table of FIG. 8, to adjust the coil dwell period 698, 798 to achieve a target secondary duration 799, 699, as indicated by the set point table.

FIG. 8 is an example lookup table 800 of target spark duration with respect to intake manifold pressure and engine speed. The values 801 in the table 800 are target secondary duration in μs. The vertical axis in this table 800 is engine speed in RPM and the horizontal axis is intake manifold absolute pressure (MAP) in kPa. During operation, the ECM 102 receives an engine speed input and an intake manifold pressure sensor input and uses the table 800 to output a target secondary duration value to the ASIC 106. In some instances, the ASIC 106 then adjust the primary coil dwell time (e.g., increments or decrements of the dwell period) based on the difference between the target value 801 and the measured spark duration. In some instances, a dwell set point achieving the target spark duration is stored in a table. In some instances, a stored dwell set point is used to initialize the engine at an ignition condition known to result in the corresponding spark duration.

An example system for controlling ignition in an internal combustion engine is an ignition control system for an engine that includes a coil connector for connecting to an ignition coil, a processor coupled to the coil connector, and a memory coupled to the processor. The memory stores instructions that, when operated by the processor, cause the processor to, in communication with the ignition coil, achieve and maintain a target spark duration by dynamically controlling a coil dwell set-point of the ignition coil. The processor is further configured to energize the ignition coil during a first ignition sequence based on the coil dwell set-point, directly measure spark duration of the first ignition sequence by monitoring a voltage reflection on a primary side of the ignition coil, adjust the coil dwell set-point for a second ignition sequence based on the target spark duration and the measured spark duration, and energize the ignition coil during the second ignition sequence based on the adjusted coil dwell set-point.

In some examples, the processor is configured to receive an engine operation parameter during the operation of the engine. In some examples, the engine operation parameter includes at least one of the following: engine speed, engine load, manifold pressure, engine power output, and in-cylinder pressure.

In some examples, the processor is configured to determine the target spark duration based on the operation parameter comprises using a lookup table to determine the target spark duration and a dwell set-point based on engine operation parameter.

In some examples, the processor is configured to increment the dwell set-point in successive ignition sequences until the measured spark duration matches the target spark duration. In some examples, the processor is configured to store the incremented dwell set-point as the dwell set-point corresponding to the target spark duration at the corresponding engine operating parameter.

Another example is a method of controlling ignition in an internal combustion engine. The method includes receiving an engine operation parameter during the operation of the engine, determining a target spark duration based on the operation parameter, and adjusting an ignition coil dwell to achieve the target spark duration.

In some examples, determining a target spark duration based on the operation parameter comprises using a lookup table to determine the target spark duration and a dwell set-point based on engine operation parameter.

In some examples, the method includes adjusting an ignition coil dwell to achieve the target spark duration includes implementing the dwell set-point for the ignition coil dwell, measuring a spark duration, and incrementing the dwell set-point in successive engine cycles until the measured spark duration matches the target spark duration.

In some examples, the method includes storing the incremented dwell set-point as the dwell set-point corresponding to the target spark duration at the specific engine operating parameter when the measured spark duration matches the target spark duration.

In some examples, the engine operation parameter includes at least one of the following: engine speed, engine load, manifold pressure, engine power output, and in-cylinder pressure.

In some examples, receiving the engine operation parameter during the operation of the engine includes directly measuring spark duration, and wherein the operation parameter includes the measured spark duration. In some examples, directly measuring spark duration includes monitoring a voltage reflection on a primary side of the ignition coil. In some examples, adjusting the ignition coil dwell to achieve the target spark duration includes controlling the coil dwell set point for each ignition event as a function of at least the target spark duration and the measured spark duration.

In some examples, the target spark duration is a predetermined fixed time value.

Another example is a method of determining and maintaining a target spark duration by dynamically controlling a primary coil dwell set-point of an ignition coil of an engine. The method includes directing electrical current to the ignition coil associated with an igniter during a first ignition sequence based on a primary dwell set-point, measuring a spark duration of the first ignition sequence, receiving an engine operation parameter from the engine, and determining a target spark duration based on the operation parameter. Then, if the measured spark duration is beyond a threshold value from the target spark duration, adjusting the primary coil dwell set-point based on the target spark duration and the measured spark duration, and, finally, directing electrical current to the ignition coil during a second ignition sequence based on the adjusted primary dwell set point.

In some examples, determining a target spark duration based on the operation parameter comprises using a lookup table to determine the target spark duration and a dwell set-point based on engine operation parameter.

In some examples, adjusting the primary coil dwell set-point based on the target spark duration and the measured spark duration includes incrementing the dwell set-point in successive engine cycles until the measured spark duration matches the target spark duration. In some instances, the dwell set-point is decremented to meet the secondary duration set point. In some instances, the adjustment of the dwell set-point need not be adjusted in discrete increments, but can be continuously adjusted.

In some examples, the method includes storing the incremented dwell set-point as the dwell set-point corresponding to the target spark duration at the specific engine operating parameter when the measured spark duration matches the target spark duration.

In some examples, measuring a spark duration of the first ignition sequence includes monitoring a voltage reflection on a primary side of the ignition coil.

Generally, one skilled in the art will appreciate that the devices and methods described herein, in some configurations, improve the life of a spark plug by reducing the spark energy. In some embodiments this reduction is achieved by directly measuring the spark duration (e.g., monitoring a voltage reflection on a primary side of the ignition coil) and adjusting the spark energy based on a look up table. Additionally, the devices and methods described herein, in some configurations, avoid excess spark energy to achieve best spark plug lifespan. One skilled in the art will also appreciate that the devices and methods described herein adapt to spark duration loss due to electrode erosion and compensate accordingly.

A number of embodiments have been described. Nevertheless, it will be understood that various modifications may be made. Accordingly, other embodiments are within the scope of the following claims.

What is claimed is:

1. An ignition control system for an engine, comprising:
a coil connector for connecting to an ignition coil;
a processor coupled to the coil connector; and
a memory coupled to the processor storing instructions that when operated by the processor cause the processor to, in communication with the ignition coil, achieve and maintain a target spark duration by dynamically controlling a coil dwell set-point of the ignition coil, the processor being further configured to:
energize the ignition coil during a first ignition sequence based on the coil dwell set-point,
directly measure spark duration of the first ignition sequence by monitoring a voltage reflection on a primary side of the ignition coil,
adjust the coil dwell set-point for a second ignition sequence based on the target spark duration and the measured spark duration, and
energize the ignition coil during the second ignition sequence based on the adjusted coil dwell set-point.

2. The ignition system of claim 1, wherein the processor is configured to receive an engine operation parameter during the operation of the engine.

3. The ignition system of claim 2, wherein the engine operation parameter includes at least one of the following: engine speed, engine load, manifold pressure, engine power output, and in-cylinder pressure.

4. The ignition system of claim 2, wherein the processor is configured to determine the target spark duration based on the operation parameter comprises using a lookup table to determine the target spark duration and a dwell set-point based on engine operation parameter.

5. The ignition system of claim 1, wherein the processor is configured to increment or decrement the dwell set-point in successive ignition sequences until the measured spark duration matches the target spark duration.

6. The ignition system of claim 5, wherein the processor is configured to store the dwell set-point as the dwell set-point corresponding to the target spark duration at the corresponding engine operating parameter.

7. A method of controlling ignition in an internal combustion engine, comprising:
receiving an engine operation parameter during the operation of the engine;
determining a target spark duration based on the operation parameter; and
adjusting an ignition coil dwell to achieve the target spark duration.

8. The method of claim 7, wherein determining a target spark duration based on the operation parameter comprises using a lookup table to determine the target spark duration and a dwell set-point based on engine operation parameter.

9. The method of claim 8, wherein adjusting an ignition coil dwell to achieve the target spark duration comprises:
implementing the dwell set-point for the ignition coil dwell,
measuring a spark duration, and
incrementing or decrementing the dwell set-point in successive engine cycles until the measured spark duration matches the target spark duration.

10. The method of claim 9, comprising:
when the measured spark duration matches the target spark duration, storing the dwell set-point as the dwell set-point corresponding to the target spark duration at the specific engine operating parameter.

11. The method of claim 7, wherein the engine operation parameter includes at least one of the following: engine speed, engine load, manifold pressure, engine power output, and in-cylinder pressure.

12. The method of claim 7, wherein receiving the engine operation parameter during the operation of the engine comprises directly measuring spark duration, and wherein the operation parameter includes the measured spark duration.

13. The method of claim 12, wherein directly measuring spark duration comprises monitoring a voltage reflection on a primary side of the ignition coil.

14. The method of claim 12, wherein adjusting the ignition coil dwell to achieve the target spark duration comprises:
controlling the coil dwell set point for each ignition event as a function of at least the target spark duration and the measured spark duration.

15. The method of claim 7, wherein the target spark duration is a predetermined fixed time value.

16. A method of determining and maintaining a target spark duration by dynamically controlling a primary coil dwell set-point of an ignition coil of an engine, the method comprising:
directing electrical current to the ignition coil associated with an igniter during a first ignition sequence based on a primary dwell set-point;
measuring a spark duration of the first ignition sequence;
receiving an engine operation parameter from the engine;
determining a target spark duration based on the operation parameter;
adjusting the primary coil dwell set-point based on the target spark duration and the measured spark duration; and
directing electrical current to the ignition coil during a second ignition sequence based on the adjusted primary dwell set point.

17. The method of claim 16, wherein determining a target spark duration based on the operation parameter comprises using a lookup table to determine the target spark duration and a dwell set-point based on engine operation parameter.

18. The method of claim 16, adjusting the primary coil dwell set-point based on the target spark duration and the measured spark duration comprises:
incrementing or decrementing the dwell set-point in successive engine cycles until the measured spark duration matches the target spark duration.

19. The method of claim 16, comprising:
when the measured spark duration matches the target spark duration, storing the dwell set-point as the dwell set-point corresponding to the target spark duration at the specific engine operating parameter.

20. The method of claim 12, wherein measuring a spark duration of the first ignition sequence comprises monitoring a voltage reflection on a primary side of the ignition coil.
